(19) United States
(12) Patent Application Publication
(10) Pub. No.: US 2025/0286304 A1
(43) Pub. Date: Sep. 11, 2025

(54) Front-Facing Locking Feature for Quick Connect Terminal

(71) Applicant: TE Connectivity Solutions GmbH, Schaffhausen (CH)

(72) Inventors: Eric M. SHERBOCKER, Middletown, PA (US); Tyler BLAIR, Middletown, PA (US); William James Moyer, II, Selinsgrove, PA (US); Michael Christopher D'Imperio, Lancaster, PA (US)

(73) Assignee: TE Connectivity Solutions GmbH, Schaffhausen (CH)

(21) Appl. No.: 18/599,364

(22) Filed: Mar. 8, 2024

(51) Int. Cl. H01R 13/432; H01R 13/115; H01R 13/187; H01R 101/00

(52) U.S. Cl. CPC H01R 13/432; H01R 13/115; H01R 13/187; H01R 2101/00

(57) ABSTRACT

An electrical terminal with a contact portion having a bottom wall with resilient contact arms extending therefrom. The bottom wall has a base portion proximate a back end of the bottom wall. The back end is removed from a mating interface of the bottom wall. A locking latch extends from and is integrally attached to the base portion. The locking latch has a free end proximate the mating interface. The free end of the locking latch is moved in a direction perpendicular to an axis of insertion as a mating terminal is inserted into the contact portion of the terminal.

### FIELD OF THE INVENTION

The present invention is directed to a quick connect electrical terminal. In particular, the invention is directed to a front facing locking arm which provides sufficient mechanical and electrical performance while decreasing the size of the terminal.

### BACKGROUND OF THE INVENTION

Quick connect electrical terminals, such as tab receptacle terminals, which are adapted for quick make and break connections with a mating terminal or mating tab, are known. Terminals of this kind are used to make an electrical connection to a male or tab terminal which is inserted and held in the socket terminal.

Known terminals incorporate rear facing locking latches the deflect during insertion. The rear facing locking latches provide high retention forces to prevent the unwanted disengagement of mating connectors tabs from the terminals. However, various problems are encountered when using such a rear facing locking latches. Such rear facing locking latches generally have short beam lengths which can cause high stresses and plastic deformations in the latches when used. The rear facing locking latches also have a tendency to fail due to secondary bending of the latches along the locking latch length, resulting in the unwanted disengagement of the tabs.

The rear facing locking latches often have upward facing latch tips which allow a user to depress the rear facing locking latches to remove the mating tabs from the terminals. The upward facing latch tips of the rear facing locking latches are prone to excessive deflection during reeling, plating, shipping and crimping resulting in inconsistent retention forces in the rear facing locking latches. In addition, as the upward facing latch tips are stamped and formed form the terminals, large cutouts are provided in the transition areas of the terminals. This can result in the terminals having limited current carrying capacity and an increased overall length.

It would, therefore, be beneficial to provide a quick connect receptacle terminal which has a locking latch which does not have the disadvantages recited above. In particular, it would be beneficial to provide a front facing locking latch which has a longer effective beam length and which eliminates the need for an upwardly facing latch tip.

### SUMMARY OF THE INVENTION

An embodiment is directed to an electrical terminal with a contact portion having a bottom wall with resilient contact arms extending therefrom. The bottom wall has a base portion proximate a back end of the bottom wall. The back end is removed from a mating interface of the bottom wall. A locking latch extends from and is integrally attached to the base portion. The locking latch has a free end proximate the mating interface. The free end of the locking latch is moved in a direction perpendicular to an axis of insertion as a mating terminal is inserted into the contact portion of the terminal.

An embodiment is directed to a quick disconnect electrical terminal. The quick disconnect electrical terminal includes a contact portion having a bottom wall with resilient contact arms extending therefrom. The bottom wall has a base portion proximate a back end of the bottom wall. The back end is removed from a mating interface of the bottom wall. The bottom wall has a first section, a locking latch and a third section. The locking latch extends from and is integrally attached to the base portion. The locking latch has a free end proximate the mating interface. The locking latch is separated from the first section by a first slot and separated from the third section by a second slot. The free end of the locking latch is moved independently of the first section and the third section in a direction perpendicular to an axis of insertion of a mating terminal as the mating terminal is inserted into the contact portion of the terminal.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is perspective view of an illustrative embodiment of a receptacle terminal according to the present invention, a mating tab terminal is shown prior to being inserted into the receptacle terminal.

FIG. 2 is a top view of the receptacle terminal of FIG. 1.

FIG. 3 is a bottom view of the receptacle terminal of FIG. 1.

FIG. 4 is a front view of the receptacle terminal of FIG. 1 prior to the mating tab terminal being inserted into a terminal receiving area of the receptacle terminal.

FIG. 5 is a cross-sectional view of the receptacle terminal of FIG. 1 positioned in a connector housing, a mating tab is shown partially inserted into the housing and the receptacle terminal.

FIG. 6 is a cross-sectional view similar to that of FIG. 5, with the mating tab fully inserted into the housing and the receptacle terminal.

FIG. 7 is a cross-sectional view similar to that of FIG. 5, with a portion of the housing engaging a locking latch of the receptacle terminal to allow the mating tab to be released from the receptacle terminal and the housing.

### DETAILED DESCRIPTION OF THE INVENTION

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

Moreover, the features and benefits of the invention are illustrated by reference to the preferred embodiments. Accordingly, the invention expressly should not be limited to such embodiments illustrating some possible non-limiting combination of features that may exist alone or in other combinations of features, the scope of the invention being defined by the claims appended hereto.

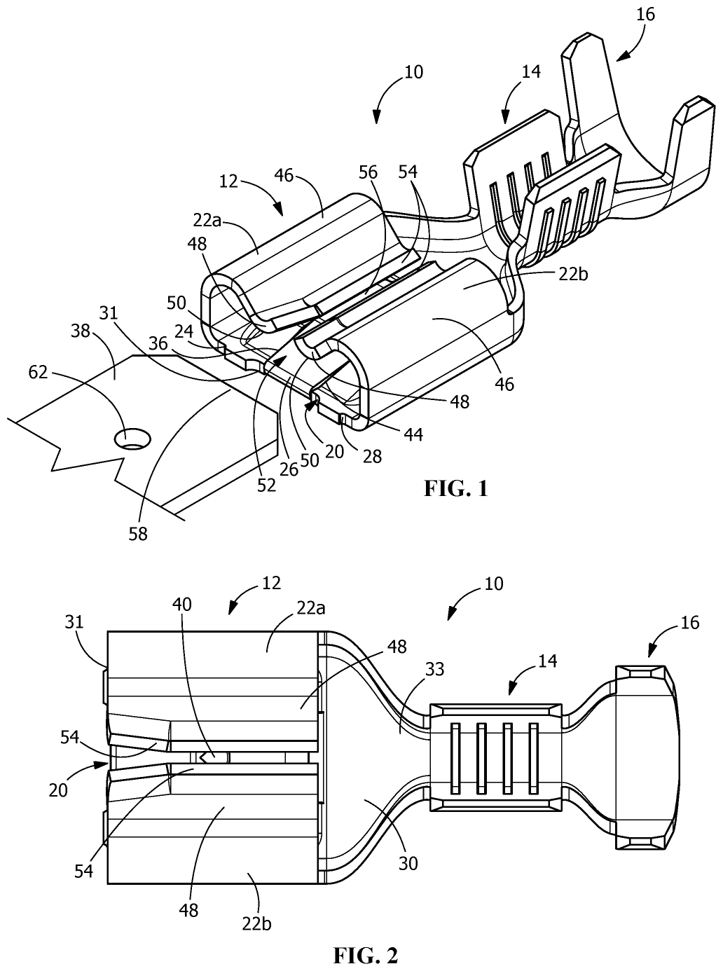

As best shown in FIGS. 1 through 4, a quick disconnect electrical receptacle, socket or female terminal 10 includes a contact portion 12, a wire barrel portion 14 behind the contact portion 12 and an insulation barrel portion 16 behind the wire barrel portion 14. The wire barrel portion 14 is configured for a crimped connection with an end of a conductive core of an insulated wire. The insulation barrel portion 16 is configured for a crimped connection with an end of the insulation coating or jacket of the wire. Although a wire barrel portion 14 and an insulation barrel portion 16 are shown, the contact portion 12 can be used with other types of termination members without departing from the scope of the invention. In the illustrative embodiment shown, the terminal 10 is stamped and formed from a metal plate having good electrical conductivity.

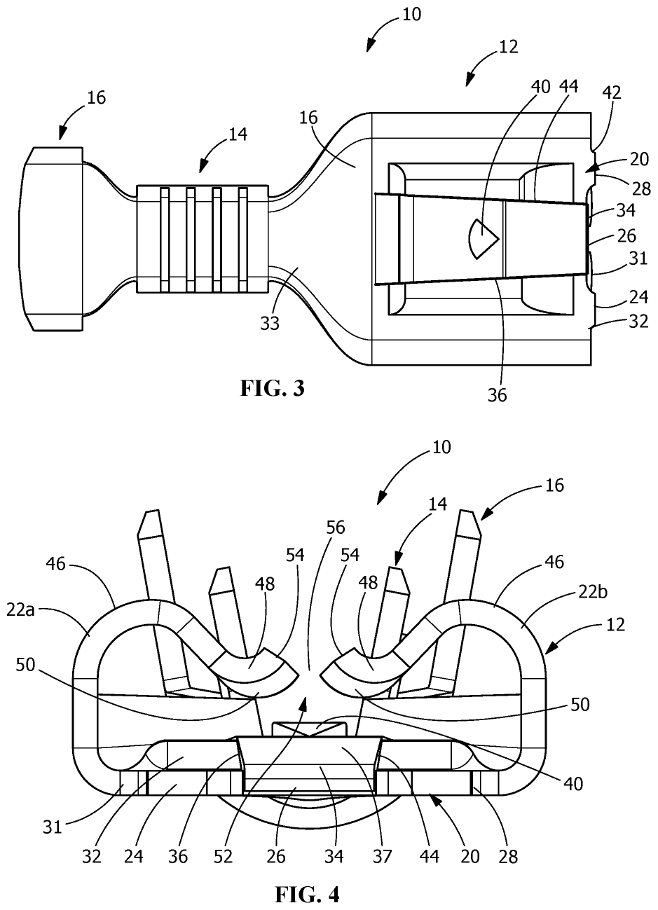

The contact portion 12 includes a bottom wall 20 and resilient contact arms 22a, 22b which extend from either side of the bottom wall 20. As shown in FIG. 3, the bottom wall 20 has a first section 24, a second section or locking latch 26 and a third section 28. The first section 24, the locking latch 26 and the third section 28 extend from, and are integrally or fixedly attached to, a base portion 30 of the bottom wall 20. The base portion 30 is spaced from a mating interface 31 of the bottom wall 20 and is positioned proximate the back end 33 of the bottom wall 20.

The first section 24 extends from base portion 30 to a free end 32. The resilient contact arm 22a extends from the side of the first section 24.

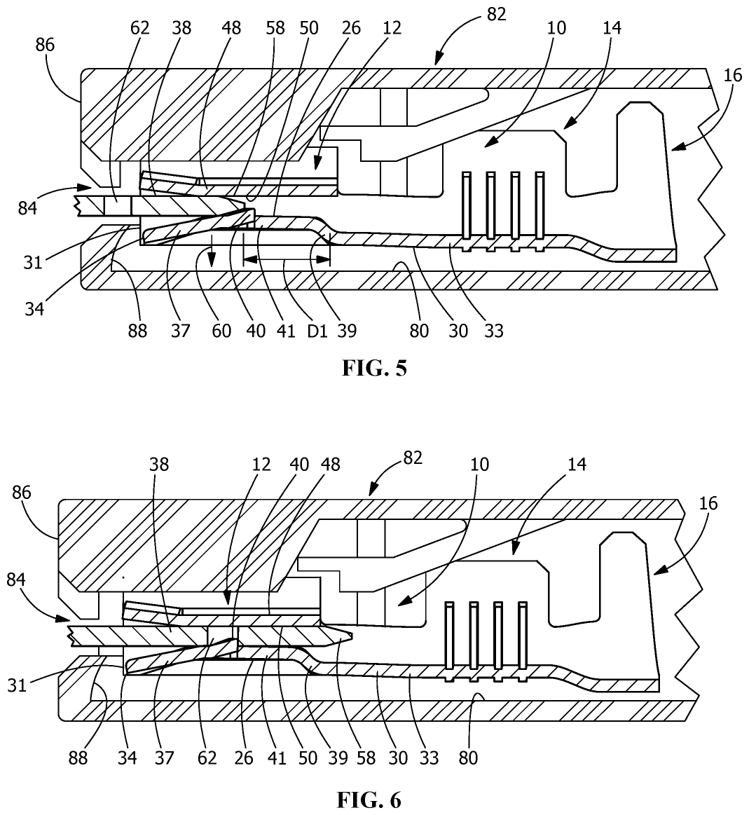

The second section or locking latch 26 extends from base portion 30 to a free end 34. The locking latch 26 is separated from the first section 24 by a slot or gap 36. The slot or gap 36 allows the free end 34 of the locking latch 26 to move independently relative to the free end 32 of the first section 24 in a direction perpendicular to the axis of insertion of a mating terminal 38 in the contact portion 12 of the terminal 10. As shown in FIGS. 5 through 7, the locking latch 26 has sloping mating section 37 provide proximate the free end 34, a bent mounting section 39 extending from the base portion 30, and a securing section 41 which extends between the mating section 37 and the mounting section 39. The bent mounting section 41 positions the securing section 41 is a plane which is above and generally parallel to a plane of the base portion 30.

The securing section 41 of the locking latch 26 has a projection or embossment 40, such as, but not limited to, a projection, detent, dimple or lance which is formed from the locking latch 26 to create a raised area on an inner surface of the locking latch 26. The projection or embossment 40 engages the mating terminal 38 as the mating terminal 38 is inserted into the terminal 10.

The projection or embossment 40 is provided is spaced from where the second section or locking latch 26 extends from and is attached to the base portion 30 by a distance D1. The length D1 is configured to provide a long effective beam length from the base 30 to the projection or embossment 40, thereby reducing stress and plastic deformation of the second section or locking latch 26 as the mating terminal 38 is inserted into the terminal 10. In the illustrative embodiment, the distance D1 is configured to provide an effective beam length which prevents the locking latch 26 from taking a permanent set as the mating terminal 38 is inserted into the terminal 10.

The third section 28 extends from base portion 30 to a free end 42. The resilient contact arm 22b extends from the side of the third section 28. The third section 28 is separated from the locking latch 26 by a slot or gap 44. The slot or gap 44 allows the free end 42 of the third section 28 to move independently relative to the free end 34 of the locking latch 26 and relative to the free end 32 of the first section 24 in a direction perpendicular to the axis of insertion of the mating terminal 38 (FIGS. 1 and 5) in the contact portion 12 of the terminal 10.

The free end 32 of the first section 24, the free end 34 of the locking latch 26 and the free end 42 of the third section 28 form the split beam mating interface 31.

In the illustrative embodiment shown in FIG. 1, each resilient arm 22a, 22b has a resilient contact section 46 with an arcuate or curled portion which extends from the bottom wall 20 to a mating terminal engaging member 48. The configuration of the resilient contact arms 22a, 22b allows the stiffness and spring rate of the resilient contact arms 22a, 22b to be controlled.

The mating terminal engagement members 48 extend from the resilient contact section 46. A mating terminal engagement surface 50 is provided on each mating terminal engaging member 48. In the embodiment shown, the mating terminal engaging member 48 extends from the resilient contact arms 22a, 22b, positioning the mating terminal engagement surface 50 at the top of a terminal mating slot 52. The configuration of the resilient contact arms 22a, 22b provides resiliency to allow the mating terminal engaging member 48 to move relative to the bottom wall 20 as the mating terminal is inserted into the mating slot 52. The mating terminal engagement surfaces 50 have an arcuate or rounded configuration. However, other configurations of the engagement surfaces 50 may be used.

The mating terminal engagement members 48 have end surfaces 54 which are positioned proximate to each other, but are spaced apart to form a slot 56. The width of the slot 56 is large enough to allow the end surfaces 54 and their respective contact arms 22a, 22b to move independently of each other. However, the width of the slot 56 is minimized to increase the beam length of the contact arms 22a, 22b. The beam length allows the contact arms 22a, 22b to have enhanced resilient or spring characteristics, allowing the contact arms 22a, 22b to move without taking a permanent set, failing or yielding. The slot 56 is positioned in line with the projection or embossment 40 of the second portion 26 of the bottom wall 20.

As shown in FIG. 4, in the initial, unstressed position, prior to the insertion of the mating terminal 38 into the mating slot 52, the embossment 40 of the second section or locking latch 26 is positioned proximate to, but not in engagement with, the mating terminal engagement surfaces 50 of the mating terminal engagement members 48. In this unstressed position, the resilient arm 22a and the resilient arm 22b are essentially mirror images of each other. The mating terminal engagement surfaces 50 of the mating terminal engagement members 48 are positioned in essentially the same plane which is transverse to the longitudinal axis of the terminal 10.

In the unstressed position, the mating terminal engagement surfaces 50 of the mating terminal engagement members 48 and the second section or locking latch 26 define the mating slot 52. In this position, the resilient arms 22a, 22b are in an unstressed position. The second section or locking latch 26 is also in an unstressed position. As previously described, the slot 36 and the slot 44 provided in the bottom wall 20 allow the second section or locking latch 26 to move independently of the first section 24 and the third section 28.

As shown in FIGS. 5 through 7, the terminals 10 are positioned in terminal receiving cavities 80 of housing 82. The terminal receiving cavities 80 have openings 84 which extend through a front surface 86 of the housing 82. Locking latch engaging surfaces 88 are provided in the terminal receiving cavities 80 proximate the openings 84. In the embodiment shown, the locking latch engaging surfaces 88 have an arcuate configuration and extend in a direction which is essentially perpendicular to the longitudinal axes of the terminal receiving cavities 80. However, other configurations of the housing 80 and the locking latch engaging surfaces 88 may be used.

Referring to FIG. 5, as the mating terminal or tab 38 is inserted into the mating slot 52 of the contact portion 12 of the terminal 10, a leading portion 58 of the mating terminal or tab 38 engages the embossment 40 of the second section or locking latch 26. As the second section or locking latch 26 is fixed to the base portion 30, the engagement of the mating terminal or tab 38 with the embossment 40 causes the embodiment 40 and the free end 34 of the second section or locking latch 26 to be elastically deformed, stressed or moved away from the mating terminal engagement surfaces 50 of the resilient arms 22a, 22b, as represented by arrow 60 in FIG. 5. As the effective beam length D1 of the second section or locking latch 26 is long, the second section or locking latch 26 does not take a permanent set as the movement occurs.

Insertion of the mating terminal or tab 38 into the mating slot 52 of the contact portion 12 of the terminal 10 is continued until the embossment 40 of the second section or locking latch 26 is positioned in a locking latch receiving opening 62 of the mating terminal or tab 38, as shown in FIG. 6. As the second section or locking latch 26 does not take a permanent set during insertion, the free end 34 and the second section or locking latch 26 are resiliently returned toward their unstressed position as the embossment 40 moves into alignment with the locking latch receiving opening 62 of the mating terminal or tab 38. With the embossment 40 positioned in the locking latch receiving opening 62 of the mating terminal or tab 38, the mating terminal or tab 38 is secured in the terminal 10 and the housing 82.

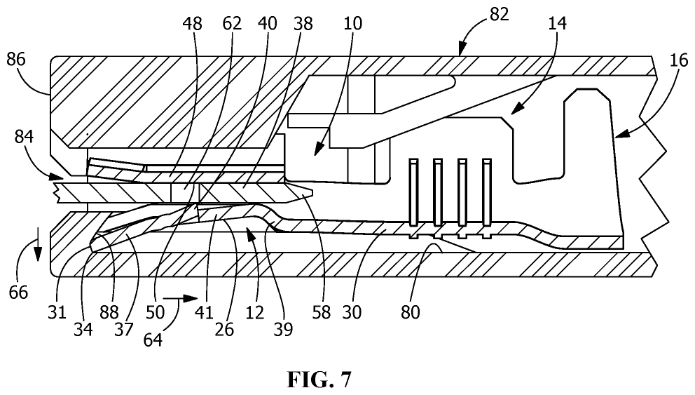

If a mating terminal or tab 38 is to be removed from the terminal 10 and the housing 80, the housing 80 is moved relative to the terminal 10 in the direction of 64 of FIG. 7. As the user pulls backward on the housing 80, the locking latch engaging surface 88 engages the free end 34 of the second section or locking latch 26. As the movement of the housing 80 continues, the free end 34 of the second section or locking latch 26 is cammed downward, in the direction of 66. This continues until the housing 80 is positioned relative to the terminal 10 in the position shown in FIG. 7. In this position, the embossment 40 is moved out of the locking latch receiving opening 62 of the mating terminal or tab 38. With the embossment 40 moved out of the locking latch receiving opening 62 of the mating terminal or tab 38, the mating terminal or tab 38 may be removed from the terminal 10 and the housing 82.

As the second section or locking latch 26 is fixed to the base portion 30, the free end 34 and the embossment 40 may be elastically deformed, stressed or moved away from the mating terminal or tab 38, as represented by arrow 60 in FIG. 5. As previously stated, the long effective beam length D1 of the second section or locking latch 26, the second section or locking latch 26 does not take a permanent set as the movement occurs.

The use of the second section or locking latch 26 with the free end 34 at the mating interface of the contact portion 12 of the terminal 10 allows the second section or locking latch 26 to be engaged from the mating interface rather than from the back of the contact portion 12, as is done in the known art. Consequently, the terminal 10 of the present invention does not require a latch tip to extend from the back of the second section or locking latch 26 beyond the resilient contact arms 22a, 22b. As the latch tip of known terminals is stamped and formed from the base of the contact section of the terminal, As the latching tip is not needed, there is no need to stamp and form the latching tip from the base. Therefore, the height and length of the terminal 10 is minimized compared to known quick disconnect terminals. In addition, as the base portion 30 of the contact portion 12 of the terminal 10 does not have a cutout section, the current capacity is greater than known quick disconnect terminals which have a cutout section.

While the invention has been described with reference to a preferred embodiment, it will be understood by those skilled in the art that various changes may be made and equivalents may be substituted for elements thereof without departing from the spirit and scope of the invention as defined in the accompanying claims. One skilled in the art will appreciate that the invention may be used with many modifications of structure, arrangement, proportions, sizes, materials and components and otherwise used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims, and not limited to the foregoing description or embodiments.

1. An electrical terminal comprising:
a contact portion having a bottom wall with resilient contact arms extending therefrom;
the bottom wall having a base portion proximate a back end of the bottom wall, the back end being removed from a mating interface of the bottom wall;
a locking latch extending from and integrally attached to the base portion, the locking latch having a free end proximate the mating interface;
wherein the free end of the locking latch is moved in a direction perpendicular to an axis of insertion as a mating terminal is inserted into the contact portion of the terminal.

2. The electrical terminal as recited in claim 1, wherein the locking latch has a securing section which is positioned in a plane which is above and essentially parallel to a plane of the base portion, the securing section engages the mating terminal as the mating terminal is inserted into the terminal.

3. The electrical terminal as recited in claim 2, wherein a projection is provided on the securing section of the locking latch.

4. The electrical terminal as recited in claim 3, wherein the projection is spaced from the base portion by a distance, the distance configured to provide an effective beam length which prevents the locking latch from taking a permanent set as the mating terminal is inserted into the terminal.

5. The electrical terminal as recited in claim 2, wherein a bent section of the locking latch extends from the base portion.

6. The electrical terminal as recited in claim 5, wherein a sloping mating section is provided proximate the free end of the of the locking latch.

7. The electrical terminal as recited in claim 6, wherein the securing section extends between the mating section and the mounting section.

8. The electrical terminal as recited in claim 1, wherein the locking latch is separated from a first section of the bottom wall by a first slot and is separated from a third section of the bottom wall be a second slot, wherein the locking latch moves independently of the first section and the third section.

9. The electrical terminal as recited in claim 8, wherein the terminal has a first resilient contact arm of the resilient contact arms which extends from the first section of the bottom wall and a second resilient contact arm of the resilient contact arms which extends from the third section of the bottom wall.

10. The electrical terminal as recited in claim 9, wherein the first section and the third section extend from and are integrally attached to the base portion of the bottom wall.

11. The electrical terminal as recited in claim 10, wherein the first resilient arm and the second resilient arm have resilient contact sections with arcuate portions which extend from the bottom wall to mating terminal engaging members.

12. The electrical terminal as recited in claim 11, wherein mating terminal engagement surfaces are provided on the mating terminal engaging members, the mating terminal engagement surfaces are positioned at a top of a terminal mating slot.

13. A quick disconnect electrical terminal comprising:
a contact portion having a bottom wall with resilient contact arms extending therefrom;
the bottom wall having a base portion proximate a back end of the bottom wall, the back end being removed from a mating interface of the bottom wall, the bottom wall having a first section, a locking latch and a third section;
the locking latch extending from and integrally attached to the base portion, the locking latch having a free end proximate the mating interface, the locking latch separated from the first section by a first slot and separated from the third section by a second slot;
wherein the free end of the locking latch is moved independently of the first section and the third section in a direction perpendicular to an axis of insertion of a mating terminal as the mating terminal is inserted into the contact portion of the terminal.

14. The electrical terminal as recited in claim 13, wherein the locking latch has a securing section which is positioned in a plane which is above and essentially parallel to a plane of the base portion.

15. The electrical terminal as recited in claim 14, wherein a projection is provided on the securing section of the locking latch.

16. The electrical terminal as recited in claim 15, wherein the projection is spaced from the base portion by a distance, the distance configured to provide an effective beam length which prevents the locking latch from taking a permanent set as the mating terminal is inserted into the terminal.

17. The electrical terminal as recited in claim 16, wherein a bent section of the locking latch extends from the base portion.

18. The electrical terminal as recited in claim 17, wherein a sloping mating section is provided proximate the free end of the of the locking latch.

19. The electrical terminal as recited in claim 18, wherein the securing section extends between the mating section and the mounting section.

20. The electrical terminal as recited in claim 19, wherein the first section and the third section extend from and are integrally attached to the base portion of the bottom wall.
